(19) United States
(12) Patent Application Publication
(10) Pub. No.: US 2005/0073156 A1
(43) Pub. Date: Apr. 7, 2005

(54) Door latch structure for a vehicle

(76) Inventor: Seung Chul Oh, Incheon (KR)

Correspondence Address: MORGAN, LEWIS & BOCKIUS LLP (SF), 2 PALO ALTO SQUARE, PALO ALTO, CA, 94306, US

(21) Appl. No.: 10/939,031

(22) Filed: Sep. 10, 2004

(30) Foreign Application Priority Data
Oct. 1, 2003 (KR) 10-2003-0068232

(51) Int. Cl. E05C 3/06

(52) U.S. Cl. 292/216

(57) ABSTRACT

A door latch structure that eliminates the return noise occurring as the fork lever is rotated excessively by impact and inertia of the fork lever and returns colliding against the ratchet lever when the door is closed. The structure also restrains the noise generated as the door opens by itself due to the force of the restitution of the weather strip when the locked door latch is released.

### CROSS-REFERENCE TO RELATED APPLICATIONS

This application claims priority of Korean Application No. 10-2003-0068232, filed Oct. 1, 2003, the disclosure of which is incorporated herein by reference.

### FIELD OF THE INVENTION

The present invention relates to a door latch used in a vehicle that allows the door locking status to be maintained or released and more particularly, to a latch that reduces the operational noise and makes the operation smooth.

### BACKGROUND OF THE INVENTION

A door latch of a vehicle is equipped with a latch mechanism at the door side that receives a striker installed on the car body. The latch mechanism is equipped with the fork lever that mechanically restrains separation of the striker as the fork lever is rotated as the striker is inserted. A ratchet is used to change the state of being able to rotate the fork lever.

### SUMMARY OF THE INVENTION

Embodiments of the present invention provide a door latch structure that reduces the return noise that can occur when the fork lever rotates as the door is closed and the inertia of the fork lever returns it, colliding against the latch lever. Noise is also reduced that is otherwise generated as the door is opened due to the force of restitution of the weather strip when the locked door latch is released.

In a preferred embodiment of the present invention, a stopper is mounted on a latch body in a direction opposed to the rotation direction of the fork lever to restrict the rotation of the fork lever when the door is locked. The stepped portion of the fork lever is formed to be blocked by the stopper. A clearance removal projection is formed between the fork lever and the latch body to locally remove the clearance between the fork lever and the latch body.

### BRIEF DESCRIPTION OF THE DRAWINGS

FIG. 1 is a perspective view showing a door latch structure for a vehicle according to an embodiment of the present invention;

FIG. 2 is a perspective view that illustrates the opened state of the door latch structure shown in FIG. 1;

FIG. 3 is a perspective view showing a projection formed at the latch body when the latch fork shown in FIG. 1 is removed; and

FIG. 4 is a cross-sectional view along line IV-IV shown in FIG. 1.

### DETAILED DESCRIPTION OF THE EMBODIMENTS

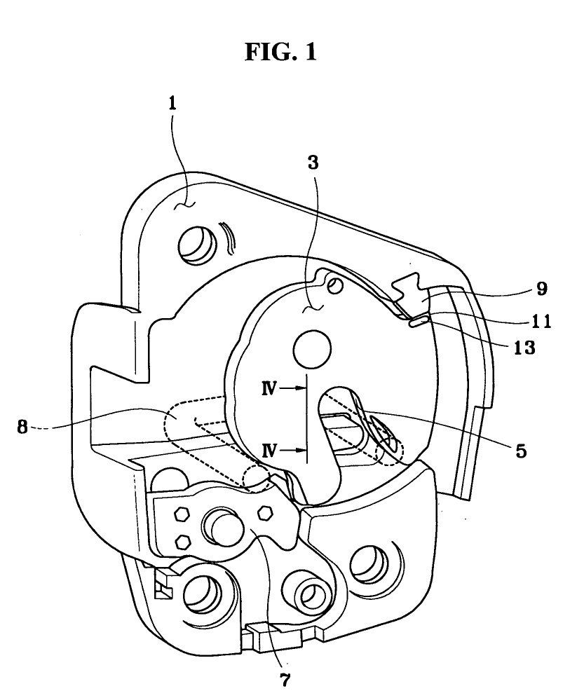

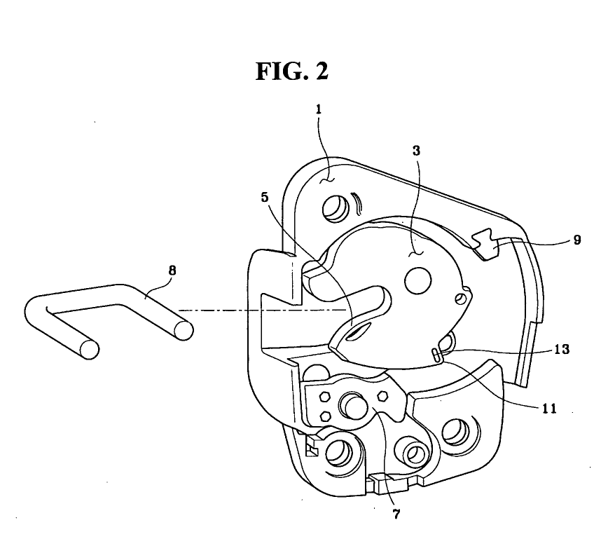

Referring to FIGS. 1 and 2, in an exemplary embodiment of the present invention, a fork lever 3 is rotatably installed at a latch body 1 mounted on the door side. The fork lever 3 is placed to be rotated clockwise (the rotation in this direction shall be called “return rotation”) in the drawing by the rotation axis and spring (not illustrated). The striker groove 5 is provided so that the striker 8 can be inserted. Ratchet lever 7 is installed on latch body 1 to prevent return rotation of the fork lever 3 by fixing the rotation state of the fork lever 3. Ratchet lever 7 allows the return rotation of the fork lever 3 by operation of an actuator or door handle.

Stopper 9 is mounted on the latch body 1 in a direction opposed to the rotation direction of the fork lever 3 to restrict the rotation of the fork lever 3 when the door is locked. A stepped portion 11 is formed at one side of the fork lever 3 to cooperate with the stopper 9. A shock-absorbing hole 13 is provided in the stepped portion 11 to absorb the impact when it collides against the stopper 9.

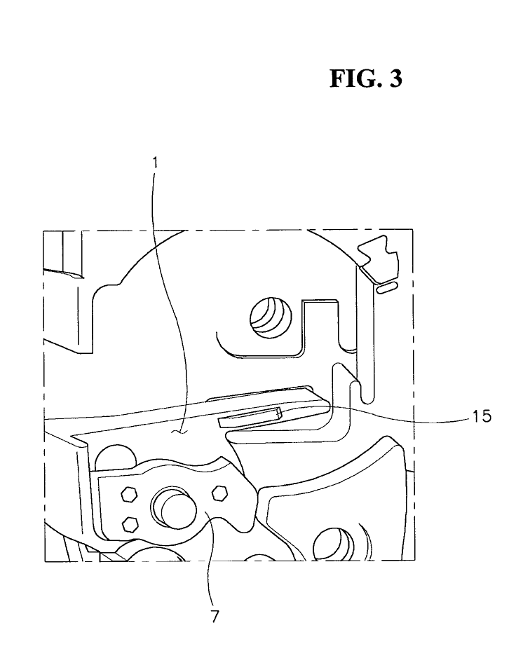

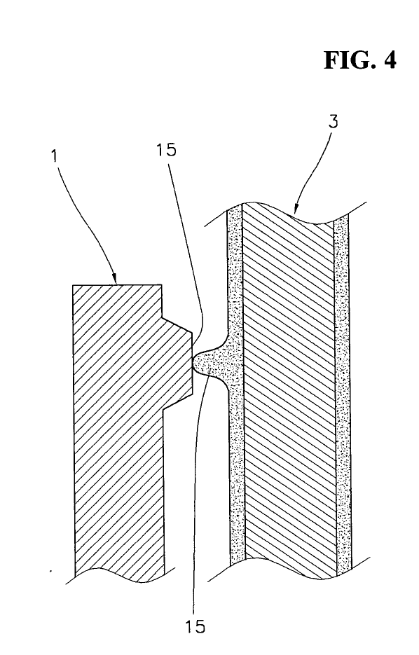

As shown in FIG. 3 (fork lever 3 is removed), projection 15, preferably in the shape of a sloped rib, is provided between the fork lever 3 and the latch body 1 to take up clearance between the fork lever 3 and the latch body 1. Projection 15 is formed to project facing against the fork lever 3 and latch body 1 on both sides in the illustrated embodiment, but in some cases it is possible to form it on only one side, against either the fork lever 3 or the latch body 1. FIG. 4 shows the cross-sectional view of the fork lever 3, wherein the outside is wrapped by a coating and part of the coating on the projection 15 on the side of the fork lever is shaped to project towards the latch body.

In operation, as in FIG. 1, the fork lever 3 is in the locked state. From this state the fork lever 3 is rotated and the striker groove 5 is opened to the left side of the drawing, which is the released state of the door latch as shown in FIG. 2. If the door is closed in the released state as shown in FIG. 2, the striker is inserted into the striker groove 5, and the fork lever 3 is rotated counter-clockwise, the striker groove 5 meets the ratchet lever 7, it is the first stage locked state. If it is rotated further, but it is in the state shown in FIG. 1, it is the second stage locked state, that is a completely locked state.

When the door of a vehicle is closed, the fork lever 3 is rotated by the power rotating the fork lever 3 generated by the insertion of the striker. If the fork lever 3 cannot stay in the state shown in FIG. 1, rotates further counter-clockwise due to rotation inertia and the impact generated by the door closing, the stopper 9 prevents the over-stroke rotation of the fork lever 3 by interacting with stepped portion 11. The impact and noise generated when the stopper 9 and the stepped portion 11 are appropriately absorbed by the elastic deformation of the stopper 9 and shock-absorbing hole 13. Therefore, the fork lever 3 does not experience over-stroke rotation even if the door is closed rapidly so the noise generated when the fork lever 3 in return rotation after the over-stroke rotation hits the ratchet lever 7 if an over-stroke rotation takes place is prevented.

On the other hand, if the ratchet lever 7 is rotated by the operation of an actuator or door handle, the fork lever 3 becomes liberated and the locked state of the door is released by the return rotation. In this condition, projection 15 restrains the fork lever 3 and the latch body 1 from performing rapid return rotation and also prevents the door from instantaneously opening by the force of restitution of the weather strip installed between the door and the car body. Projections 15 are in contact with the fork lever 3 and the latch body 1, exerting friction force thereon. This friction force offsets part of the elastic force of the spring for the return rotation of the fork lever 3 and the force of restitution of the weather strip and thus prevents the door from making a noise sounding like a bottle cap opening that can occur when a conventional door latch is released when the door is opened.

As described above, the user can have a quiet and smooth feeling when the door is open and closed as the over-stroke rotation of the fork lever 3 is prevented and the sudden return movement is deterred as described above. Thus, embodiments of the present invention can remove the return noise as the fork lever is rotated excessively by the impact and the inertia of the fork lever and returns colliding against the latch lever when the door is closed and suppress the noise generated as the door opens by itself due to the force of restitution of the weather strip when the locked door latch is released, and thus can provide the quiet and smooth feel of operation.

1. A door latch structure for a vehicle, comprising:
a stopper mounted on a latch body facing a direction opposed to rotation of a fork lever to restrict the rotation of the fork lever when the door is locked; and
a stepped portion on the fork lever formed to abut against the stopper at a limit of rotation of the fork lever.

2. The door latch structure for a vehicle as in claim 1, further comprising a shock-absorbing hole in the stepped portion to absorb the impact when it collides against the stopper.

3. The door latch structure for a vehicle as in claim 1, wherein a projection is formed between the fork lever and the latch body to take up clearance between the fork lever and the latch body.

4. The door latch structure for a vehicle as in claim 3, wherein said projection comprises two separate projections, each formed to project facing against the fork lever and latch body on opposite sides.

5. A door latch structure for a vehicle, comprising:
a latch body;
a fork lever rotatably mounted on the latch body and having a striker groove configured to receive a striker;
a stepped portion formed on the periphery of the fork lever, spaced away from the striker groove; and
a stopper formed on the latch body facing the stepped portion, wherein said stopper and stepped portion are positioned to cooperate to limit rotation of the fork lever beyond a predetermined limit of travel.

6. The latch structure of claim 5, wherein said stepped portion has a face facing the stopper and defines a hole spaced from said face at a distance to provide resiliency to said face.

7. The latch structure of claim 5, wherein the stopper comprises a resilient material.

8. The latch structure of claim 5, further comprising a projection formed on the latch body and sized to cooperate with the fork lever to slow rotation thereof through frictional contact.
